(19) United States
(12) Patent Application Publication
(10) Pub. No.: US 2003/0105683 A1
(43) Pub. Date: Jun. 5, 2003

(54) Method of ordering pharmaceutical and vaccine products

(76) Inventors: Frank M. Fratarcangeli, Langhorne, PA (US); Kevin C. Austin, Souderton, PA (US); Robert Stephen Burgess, Media, PA (US); William H. Cameron, Sellersville, PA (US); Robert T. deHaan, Schwenksville, PA (US); Robert C. Houser, West Norriton, PA (US); Paul C. Huzar, Lansdale, PA (US); Scott K. Mengel, Kutztown, PA (US); Michael Piede, Perkiomenville, PA (US); Shawn C. Smith, Bryn Athyn, PA (US)

Correspondence Address: MERCK AND CO INC, P O BOX 2000, RAHWAY, NJ, 070650907

(21) Appl. No.: 10/286,029

(22) Filed: Nov. 1, 2002

Related U.S. Application Data
(60) Provisional application No. 60/336,003, filed on Nov. 1, 2001.

(51) Int. Cl. G06F 17/60

(52) U.S. Cl. 705/27; 705/2

(57) ABSTRACT

A method and system for ordering pharmaceutical and vaccine products via the Internet, characterized by an electronic catalog providing product information wherein pricing information may be adjusted according to variable customer pricing schedules. After product purchase, the system is capable of tracking the location and estimated arrival of order shipments in real time.

### FIELD OF THE INVENTION

The present invention is directed to a method of ordering products, e.g. pharmaceuticals and vaccine products, by way of electronic data interchange.

### BACKGROUND OF THE INVENTION

Manufacturers are constantly looking for ways to conduct business-to-business transactions with customers in a more time efficient and cost savings manner. One current technology of product distribution has focused on conducting business via the telephone, mail or fax machine with some of the larger, more sophisticated customers using Electronic Data Interchange (EDI).

The present invention relates to a method of supplementing product-differentiation efforts with service offerings that reduce the overall cost of transacting business between a manufacturer and its direct ordering customers, while at the same time providing additional benefits to customers that are not readily available via the traditional commerce channels.

The diversity of the pharmaceutical and vaccine purchasing, and decision-making processes among purchasers make them particularly well suited to the customer-centric nature of the Internet. The Internet is believed to provide the pharmaceutical and vaccine marketplace with an efficient and effective channel for conducting business transactions among manufacturers, distributors, and the medical profession, e.g. doctors, pharmacists, and hospitals.

One benefit for manufacturers, distributors and medical professional is the ability to instantaneously view new product information, e.g. price, formularies, unit sizes, etc., and make desirable purchases if desired. Given the significant impact of pharmaceutical and vaccine purchases on hospital and doctor inventories, cash-flow management strategies, and objectives, electronic data interchange methods of ordering will enable the medical profession to better manage time, costs, and cash flow.

The present invention will assist hospitals and doctors to better manage their time by providing them with ready access to on-line ordering, order tracking and continuously available, and product information. The invention provides cost savings benefits by enabling hospitals and pharmacists to view and interpret their pharmaceutical and vaccine ordering history.

The invention also provides the ordering community with means of better predicting their future needs as well as manage inventories. The invention will also improve cash flow by providing means of charging an order to a credit card, and the ability to review an invoice on-line.

### SUMMARY OF THE INVENTION

The present invention can be characterized as a method of ordering pharmaceutical products and vaccines on-line with security and confidentiality, wherein credit cards or other payment means can be utilized. Product information necessary for a large-scale purchaser to make critical purchasing decisions is provided by the invention. The invention will assist medical professionals such as retail pharmacies, wholesalers, physicians, hospitals, alternate care pharmacies, government purchasers, and the like to manage pharmaceutical and vaccine inventories and budgets. The invention will also provide cost saving benefits by enabling hospitals and pharmacists to view and interpret pharmaceutical and vaccine ordering histories, review and pay invoices, and manage backorders.

The present invention allows a customer to directly perform all phases of ordering products, particularly pharmaceutical products and vaccines, while retrieving information, selecting billing account and designating shipping location, selecting products, and receiving confirmation of orders. Customers are able to view available order information, obtain product information, and the like, at times suitable for the customer without the need to interact with a manufacturer's representative. Customers are able to perform basic functions of accounts payable; they will be able to pay invoices still outstanding on accounts, and obtain faxed copies of invoices or credits still outstanding on accounts. Customers can view outstanding backordered items, have the ability to cancel any backordered items that are outstanding on their accounts, and cancel any item that is no longer desired.

The invention further allows the user to set site preferences of certain variables as well as edit personal profiles. The present invention, placed on the World Wide Web, may be accessed by personal computer-type Internet connection, such as a laptop, desktop computer, personal desktop assistance, and the like.

### DESCRIPTION OF THE DRAWINGS

In accordance with the present invention, pharmaceuticals and vaccines may be characterized by a method accomplished in combination with a plurality of corresponding web pages illustrated in the figures, wherein:

FIG. 1 illustrates a screen for a customer or user log-in to a website using a user ID and password;

FIGS. 2a, b and c illustrate customer screens for changing a customer password;

FIG. 3 illustrates a customer screen for a home page, wherein the user has successfully logged into the website;

FIGS. 4a, b and c illustrates screens user a profile page, a screen for changing a password, and a screen for changing a security question related to the password;

FIG. 5 illustrates a site preference screen wherein the user may customize catalog and ordering pages;

FIG. 6 illustrates a customer billing account screen, wherein the choice for billing a purchase to two or more accounts is optional;

FIG. 7 illustrates a customer shipping address screen, wherein one of several addresses for order shipment may be designated;

FIG. 8 illustrates a customer catalog screen for order history;

FIG. 9 illustrates a customer full catalog screen, wherein products may be selected according to an alphabetical listing;

FIG. 10 provides a customer quick order screen;

FIG. 11 illustrates a customer shopping cart screen;

FIG. 12 illustrates a customer screen for adding new credit cards to the account;

FIG. 13 illustrates a customer order confirmation screen;

FIG. 14 provides a customer order cancel screen;

FIG. 15 illustrates a customer order history and order tracking search screen;

FIG. 16 illustrates a customer order history and order tracking search results screen;

FIG. 17 illustrates a customer order information screen;

FIG. 18 illustrates a customer order shipping information page;

FIG. 19 illustrates a customer shipment details screen;

FIG. 20 illustrates a customer product information screen;

FIG. 21 illustrates a customer screen for different formularies of a given product;

FIG. 22 illustrates a customer screen detailing product package specifications;

FIG. 23 illustrates a customer log out screen;

FIG. 24 illustrates a customer fact screen;

FIG. 25 illustrates a customer screen for contacting the product manufacturer;

FIG. 26 illustrates a customer contact confirmation screen;

FIG. 27 illustrates a customer screen for searching invoices and credits;

FIG. 28 illustrates a customer screen for displaying results of invoice and credit search results;

FIG. 29 illustrates a customer screen for fax requests of invoice and credit search results;

FIG. 30 illustrates a customer screen for invoice payments by credit card;

FIG. 31 illustrates a customer screen for searching backorders;

FIG. 32 illustrates a customer screen for displaying backorder search results; and

FIG. 33 illustrates a customer screen for verification of cancellation of backorders.

### DETAILED DESCRIPTION OF THE INVENTION

In one embodiment of the present invention, customers may purchase pharmaceutical and vaccine products over an EDI, e.g. the Internet via personal computer, hand-held device, etc., and at the same time get additional services and information. Accordingly, the invention provides a method of ordering pharmaceutical and vaccine products over an EDI, wherein product information may be combined with the products, and shipping and receiving of orders may be tracked up to and including receipt by the customer.

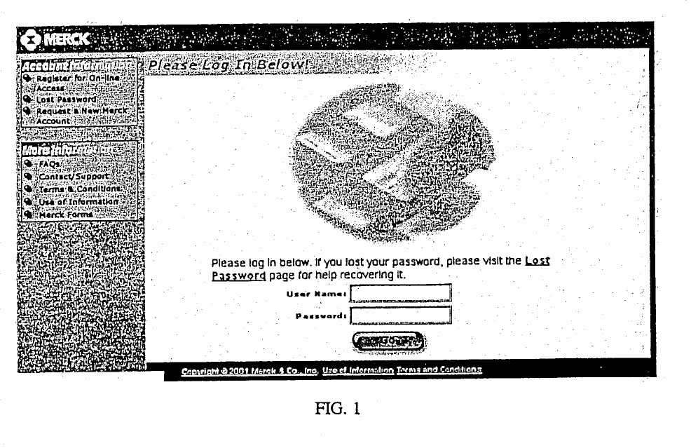

Entry to the Website may be provided to customers by assigning different registrants user IDs and passwords. Upon appropriately entering such user ID and password, a customer may order a manufacturer's product, check on orders (‘order history’), and access product information. FIG. 1 illustrates a screen wherein the user may log into the system. The screens will display error messages if there is a problem logging in. If a custom log in message has been specified, that message is also displayed. Every customer screen is associated with a “pull down” list for product ordering, order status, and other information, e.g. product information, FAQs, contact/support, order contract terms and conditions, log out, use of information, and return home.

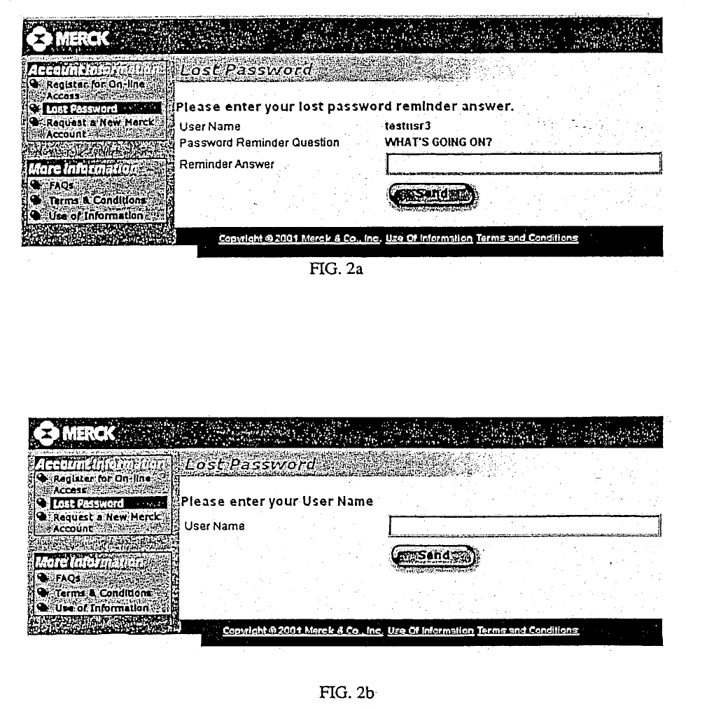

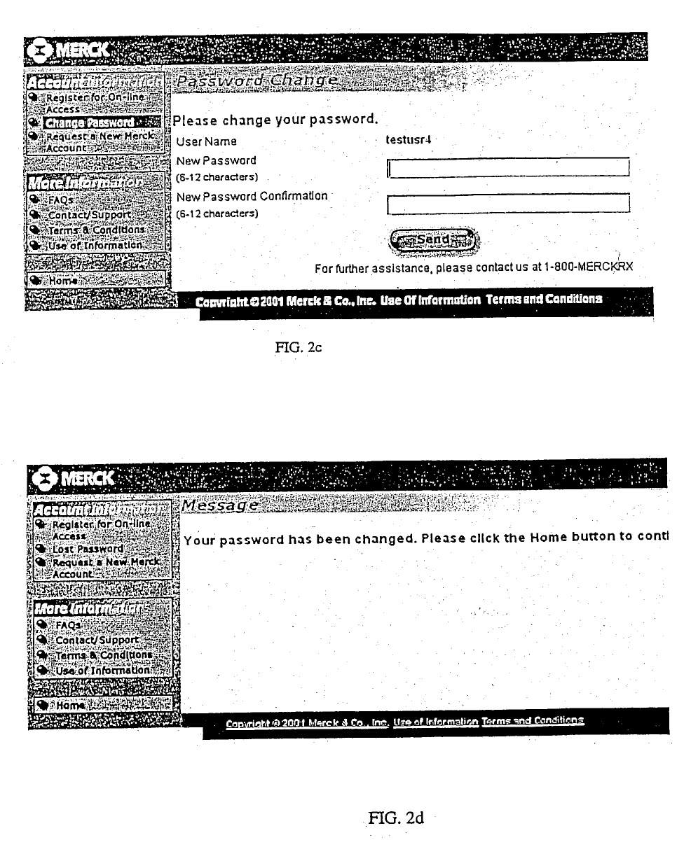

FIGS. 2a, b and c illustrate lost password screens that allow the customer/user to access a password in situations where it has been forgotten. FIG. 2a provides a screen for requesting a user name; FIG. 2b provides a screen for a user reminder question, i.e. password hint, provided by the user upon establishing a password; and FIG. 2c illustrates a screen for displaying a confirmation message after a password has been changed. These screens essentially allow a user that has lost a password to automatically recover it without intervention by the manufacturer's/marketer's staff.

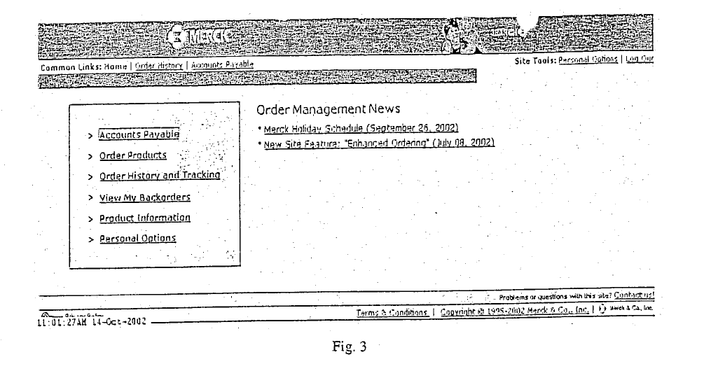

FIG. 3 illustrates a home page screen that welcomes the user after a user ID and password have been successfully entered. The user is prompted to choose one of several options, or telephone the manufacturer's representative. This screen allows the user to access the highest-level site functionality. In one embodiment the invention allows the user to display 4 recent news articles regarding the product manufacturer. Conditions and options for utilizing the screen may be as follows:

1. If the user clicks on the “Order Products” icon, the user is taken to the “Select A Billing Account” page;

2. If the user clicks on the “Product Information” icon, the user is taken to the “Product Information—List of “A” Products” page;

3. If the user clicks on the “Order History and Tracking” icon, the user is taken to the “Order History and Tracking Search” page;

4. If the user clicks on the “Edit Profile” link from the menu on the left-hand side, the user is taken to the “Edit Profile” page;

5. If the user clicks on the “Site Preferences” link from the menu on the left hand side, the user is taken to the “Site Preferences” page; and

6. If the user clicks on one of the “Recent News” links, the user is taken to that news article.

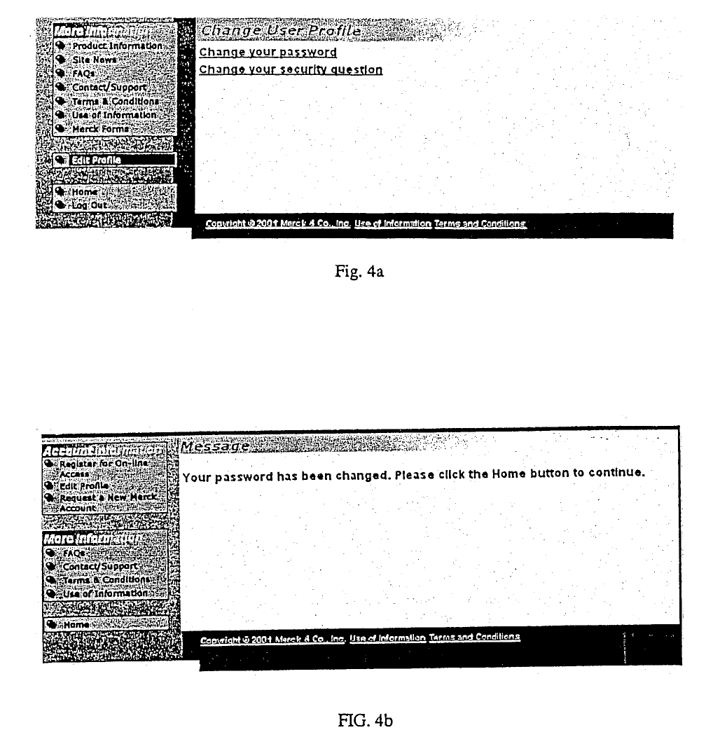

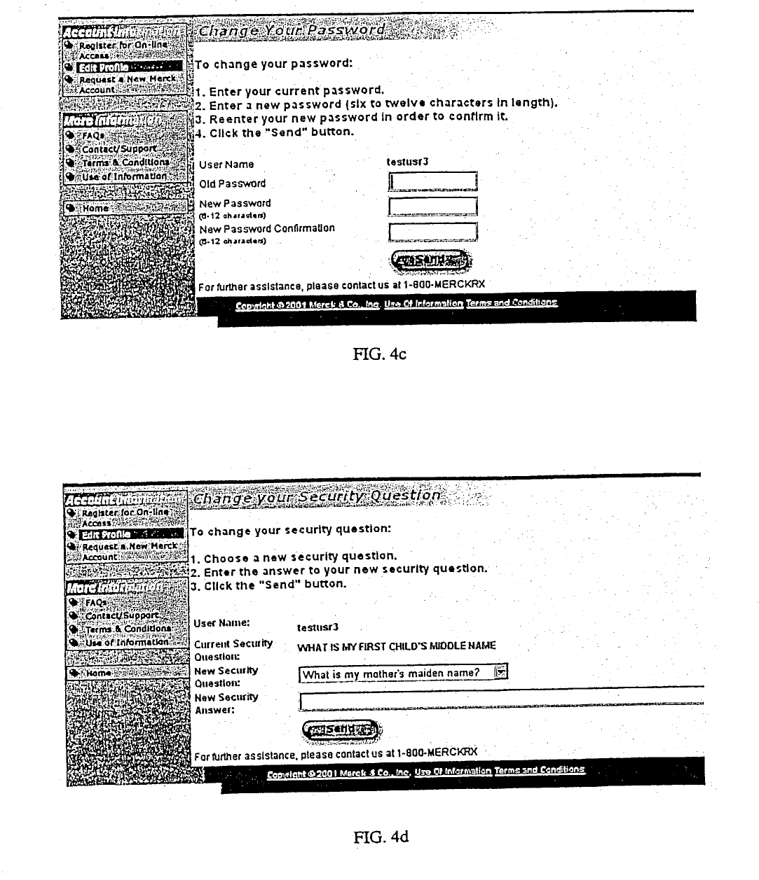

FIG. 4a illustrates a customer screen for changing a password or changing a security question. The user may edit their user profile, including sub-options on the page of “Change Your Password” and “Change Your Security Question”. FIG. 4b illustrates the customer screen for changing a password, and FIG. 4c provides a screen confirming that the password has been changed. FIG. 4d illustrates the customer screen for changing a security question.

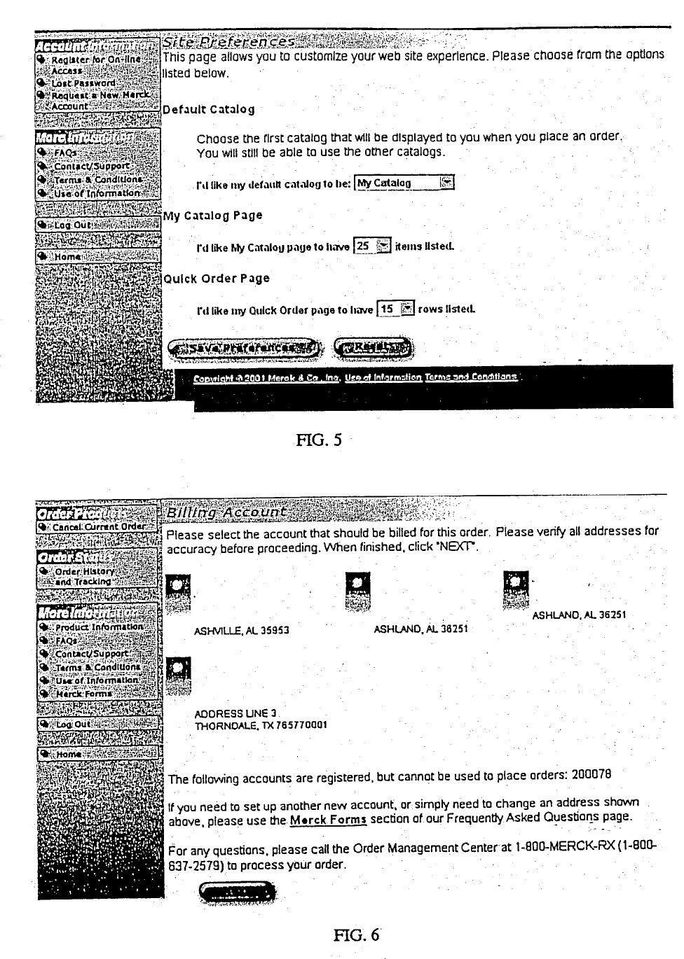

FIG. 5 illustrates a customer screen for allowing the user to customize preferred pages on the site. It offers the ability for users to choose a default catalog, the size of customer's “My Catalog” page, and the size of his “Quick Order” page.

FIG. 6 illustrates a billing account screen. Ordering may be performed with respect to billing accounts of the customer. Thus, in one embodiment of the present invention a customer may have access to an account database or the like containing customer account information. Upon entering the account database, a customer may select from a plurality of accounts if the customer has established plural accounts.

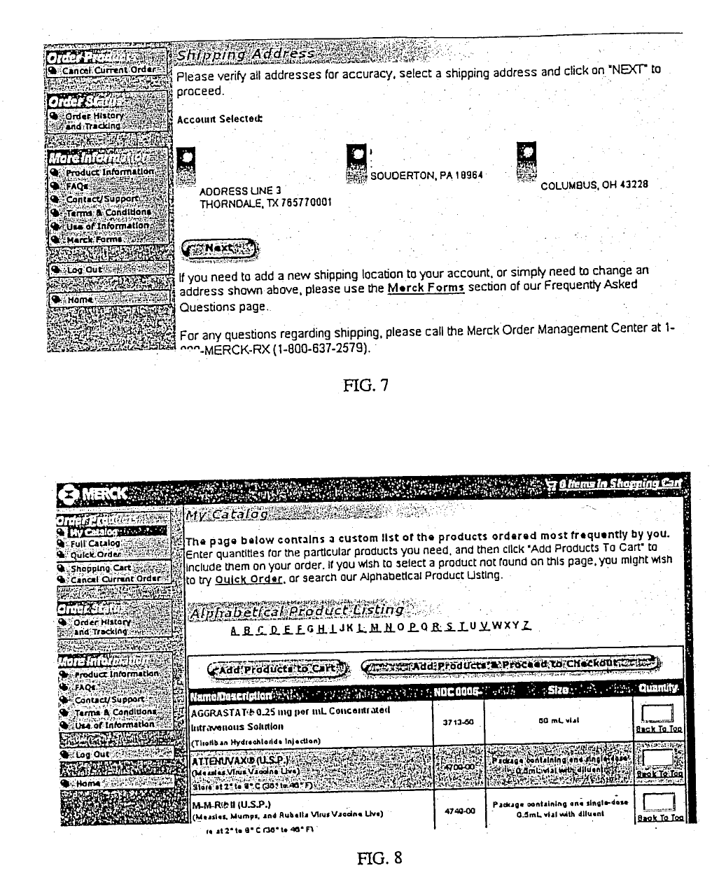

FIG. 7 provides a customer's shipping address screen. If the customer has several shipping addresses that have been previously used or inserted into the system, he may choose the shipping designation from the addresses displayed. The pharmaceutical and vaccine products ordered by a customer may be shipped to any of several shipping locations available for that customer. When ordering, the customer may select from a plurality shipping locations when ordering, if the customer has more than one shipping location. Information regarding shipping locations of a customer may be available from customer records maintained in a manufacturer's database.

FIG. 8 illustrates a customer catalog screen that can provide records of orders within the previous 90 days. This frequency is determined by the number of times that item appears on a particular order. Cost of the item or quantity of the item need not be taken into consideration. The customer's catalog page may be updated on a nightly basis—any orders placed will not immediately impact the contents of the catalog product list. If this username has one account and that account has only one shipping address, the account number and billing address will be displayed in the upper right hand corner of the page.

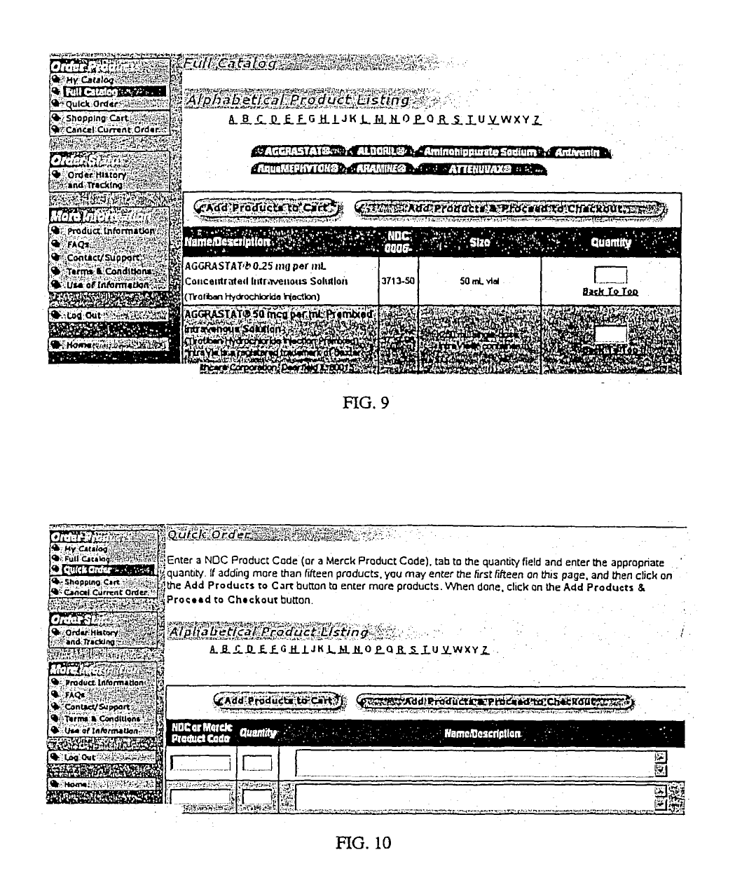

FIG. 9 illustrates a full catalog page screen that may be searched by selecting a letter of the alphabet that the product begins with. Thereafter, the names of all products within that category will appear for further selection of a product. A product description containing the name, National Drug Code (NDC) and size will appear. The customer is prompted to select the quantity of products desired, and whether to add the product to a shopping cart and continue shopping, or add the product to a shopping cart and check out.

FIG. 10 illustrates a quick order page wherein the customer may enter a NDC or manufacturer's product code, or the product description and quantity. This screen is handy for orders wherein the customer known the desired product. Up to 15 products may be selected using this page, wherein additional pages are available after completion of the initial page. Thereafter, the “Add Products to Cart” or “Add Product & Proceed to Checkout” button may be selected for completing the order.

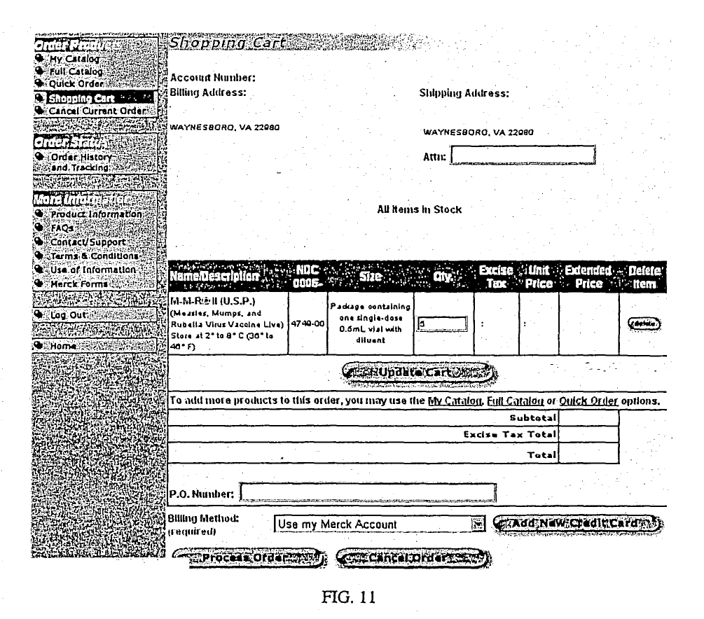

FIG. 11 provides a shopping cart view of the product description, NDC code, size, quantity, tax, unit price, extended price, and delete item option. If an item is deleted from the shopping cart, an “Update Cart” button is provided. The order cost subtotal, tax, and total purchase price is then displayed. A purchase order number will be displayed, and the customer may select an account for billing the order thereto.

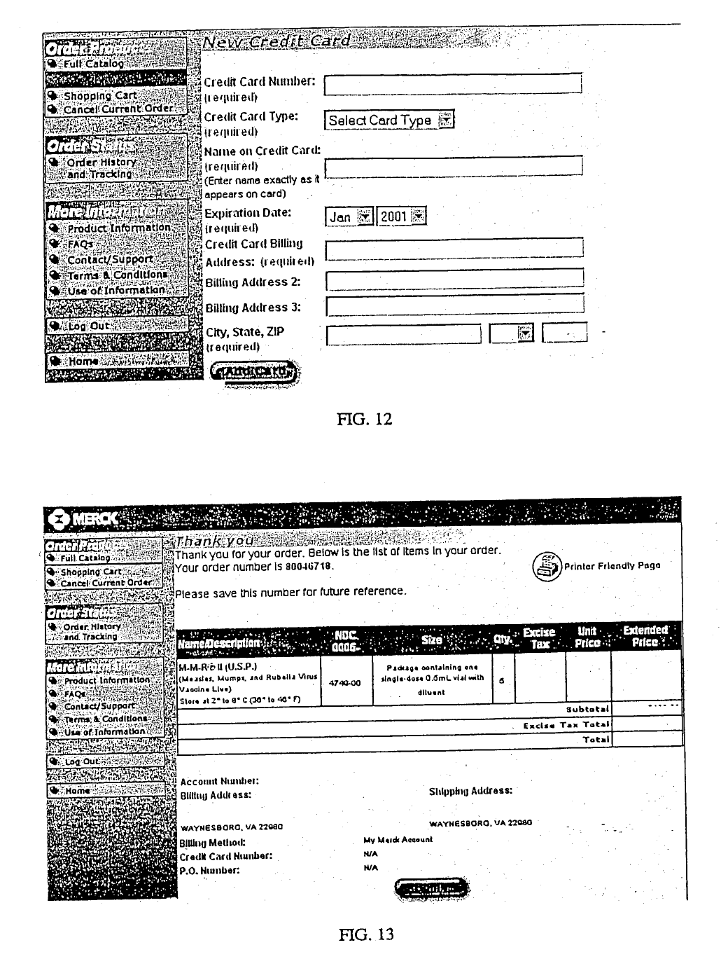

FIG. 12 provides a customer screen for adding a new credit card to an existing billing account. The screen provide fields for credit card number, type of card, name on the credit card, expiration date, and credit card billing address information.

FIG. 13 illustrates an order confirmation screen wherein a customer's individual orders are listed along with description, NDC code, size of product, quantity, tax, unit price, and extended price. Other information such as account number, billing address, shipping address, purchase order number, etc. is provided with the confirmation.

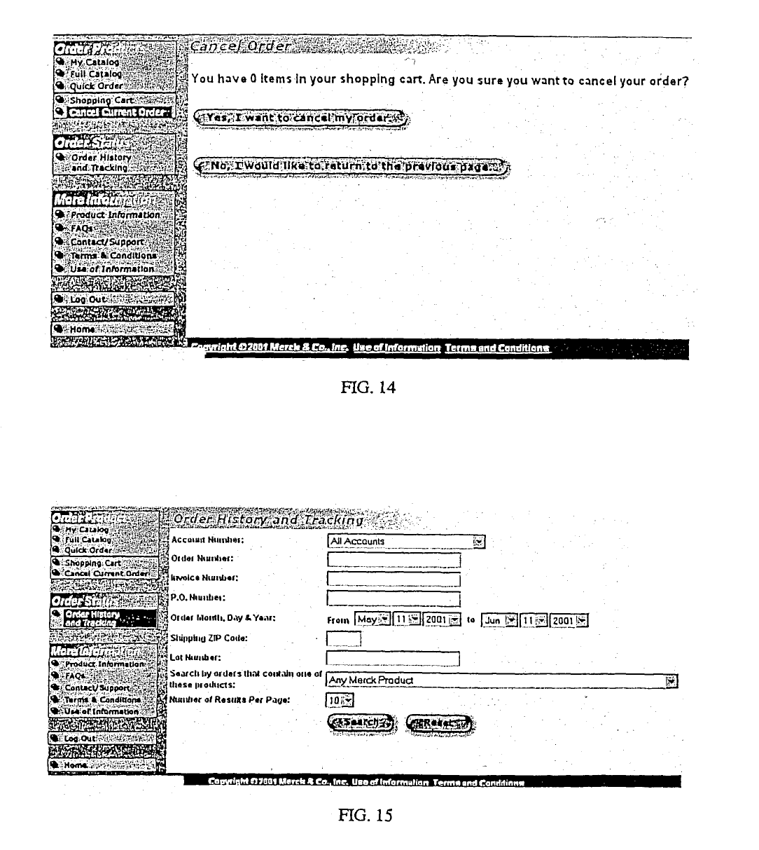

FIG. 14 provides an order cancellation screen, wherein the customer may cancel all orders and return to the previous page. Cancellation and return to previous page buttons are provided on the page.

FIG. 15 provides a screen for order history and tracking, wherein any account, order, invoice, and/or purchase numbers may be used to track an order shipment. Other required information may be the order date, shipping zip code, lot number, product description, and the number of results to be displayed per page. Afterwards, a “Search” or “Reset” button may be selected to continue tracking the shipment.

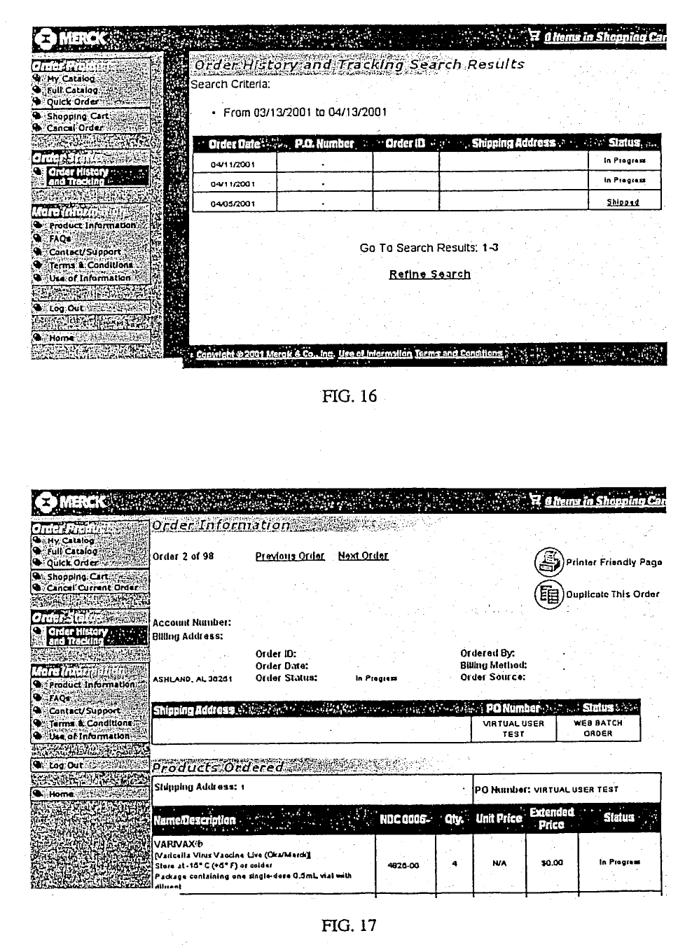

FIG. 16 illustrates the result screen for the information required in the order history search. According to the search criteria, the dates of the order are displayed along with the particular order date, purchase order number, order identification, shipping address, and order status.

FIG. 17 provides the order information page of the invention, wherein vital customer information such as account number, billing address, order ID, order date, order status, person placing the order, billing method and order source are displayed. A description of each order, NDC, quantity, unit price, extended price, and status of order are further displayed on the screen. A button for printing the page is also provided.

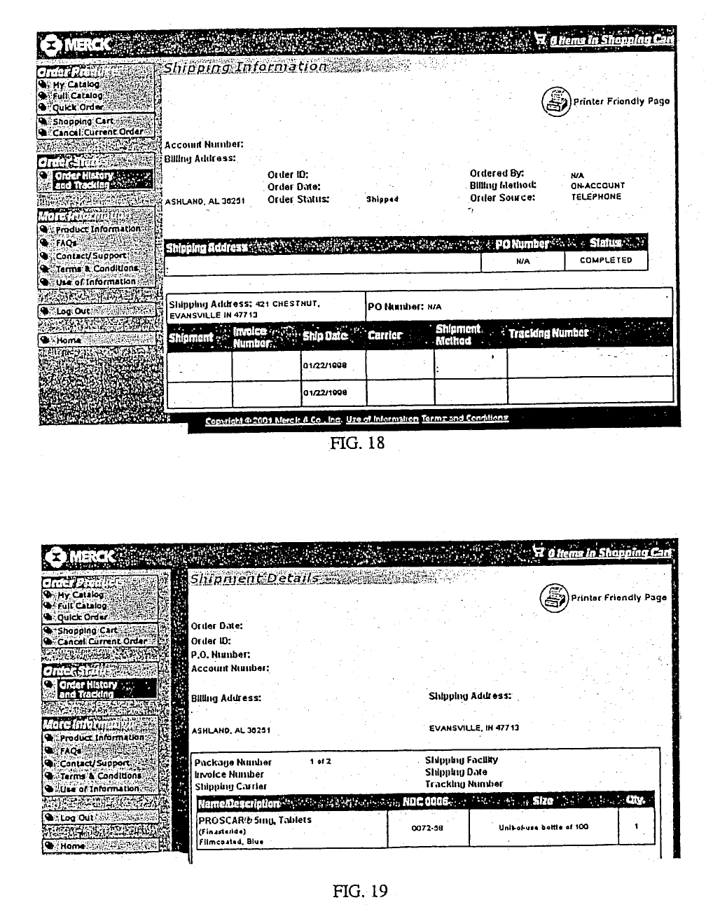

FIG. 18 provides a shipping information screen containing essential information displayed in the order information screen as well as the shipping address and purchase order number for the order. A button for printing the page is also provided.

FIG. 19 illustrates a shipment details screen, wherein all line items included in a given shipment are displayed. A button for printing the page is also provided.

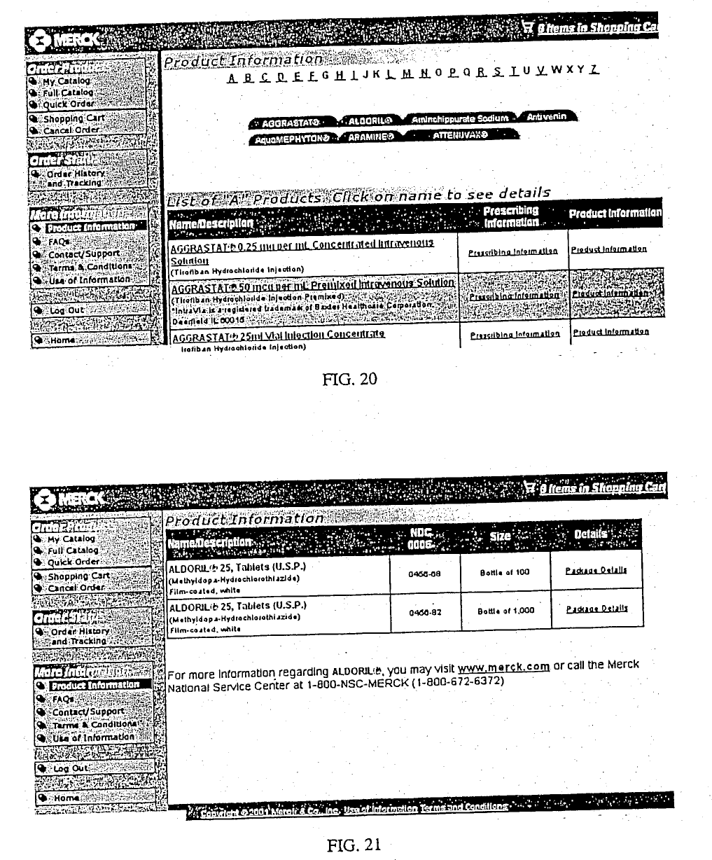

FIG. 20 provides all product groups under a given letter of the alphabet with links to the most recent “Prescribing Information” (PI) for that product, and a link to the “Product Group Information” page under the “Product Information” header. The link to the PI page must be checked on a periodic basis for reorganization since some URLs may change over time.

FIG. 21 illustrates the product information screen wherein all information for a product group is displayed with links to the package details for each product group. Vital product information including NDC code, package size and product detail links are provided to describe the pharmaceutical or vaccine product.

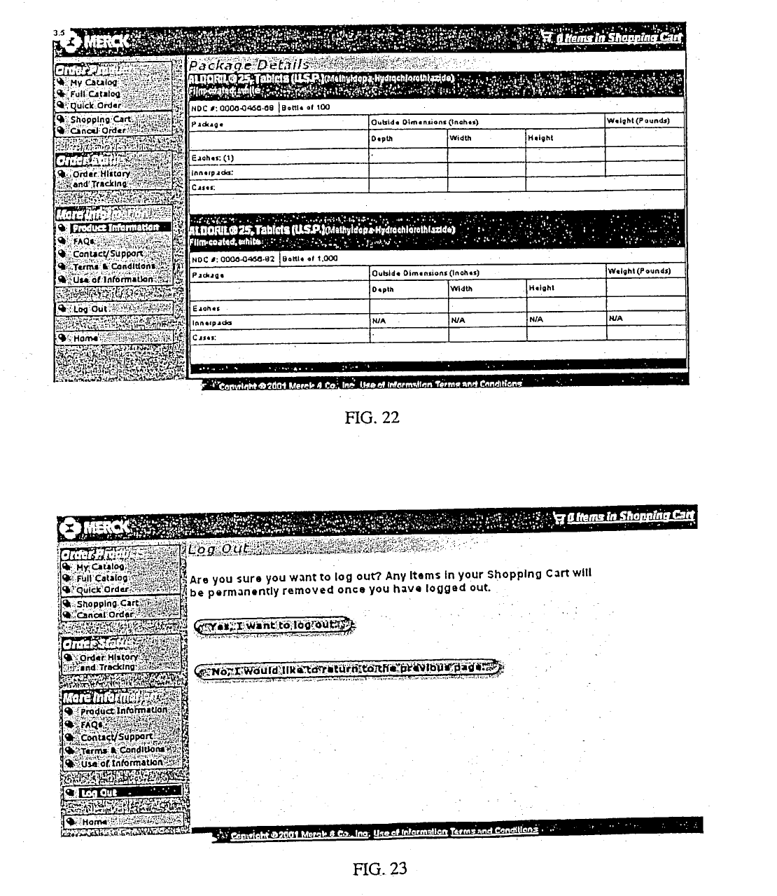

FIG. 22 illustrates the package details page, wherein all package details, including height, width, depth, weight, and package type are displayed for all PSFs in a given product group. At the upper right of the screen, the number of items in the shopping cart is provided.

FIG. 23 provides the log out screen, wherein buttons are presented for logging out or returning to the previous page. Afterwards, the user may visually confirm that he has logged out of the site.

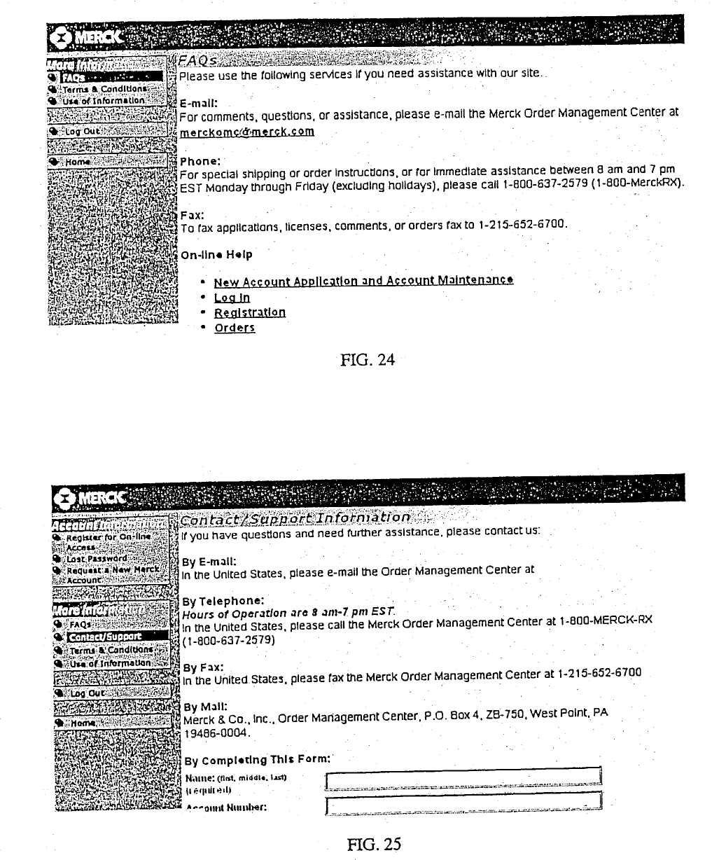

FIG. 24 illustrates the FAQ screen for the system, wherein the user may send an email message to the manufacturer concerning comments, questions, or to request assistance. Telephone and facsimile numbers are also provided, and the user may go to an on-line help links for log in, registration, orders, and new account applications and maintenance.

FIG. 25 provides a contact/support page wherein the user may request a customer support personnel to contact them regarding a question or for assistance.

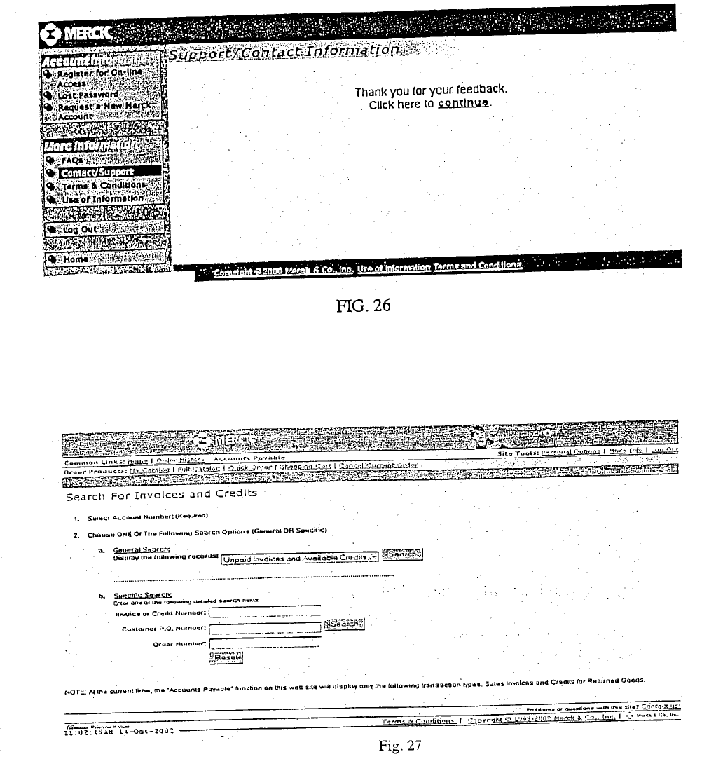

FIG. 26 provides a customer contact screen wherein the user may request additional product information from a customer service representative or provide comments and suggestions regarding the products, the site, billing, shipping, etc.

FIG. 27 provides a customer screen for searching for invoices and credits, wherein the customer can search an account for unfilled orders. From the home page, by clicking “Accounts Payable” the search screen will appear. After inputting an account number, any one of three options may be utilized, as follows: “Unpaid Invoices and Available Credits,” “Invoices: Eligible for Discount,” or “Invoices: Past Due Only.” If desirable, the customer my use one of the specific search fields found on the lower half of the screen, i.e. “Invoice or Credit Number,” “Customer P.O. Number,” or “Order Number.”

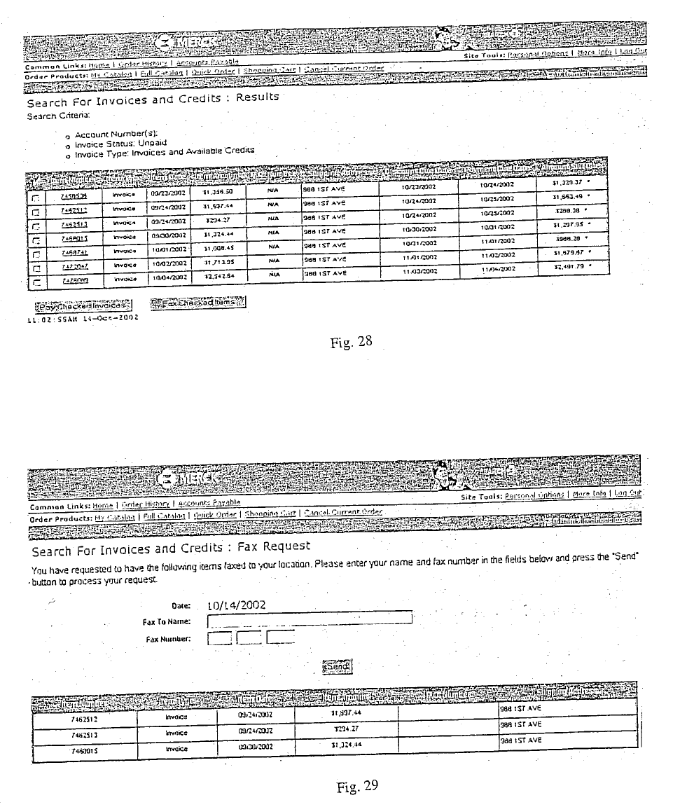

FIG. 28 provides a customer screen for displaying invoice and credit search results, wherein the customer may select an invoice to pay an open or unpaid invoices, or request a fax copy of an open invoice or credit item. In a table format of columns and rows a listing of open or backorder items that match the search criteria are displayed. From this screen, the customer may print the invoice, or select particular invoices and proceed by 1) paying the open invoices or 2) request faxed copies or open invoices.

FIG. 29 provides a customer screen for requesting a faxed copy of an invoice or credit item. By inputting the customer's name and fax number to whom the invoice is to be sent and clicking “Send,” the customer will complete the fax request.

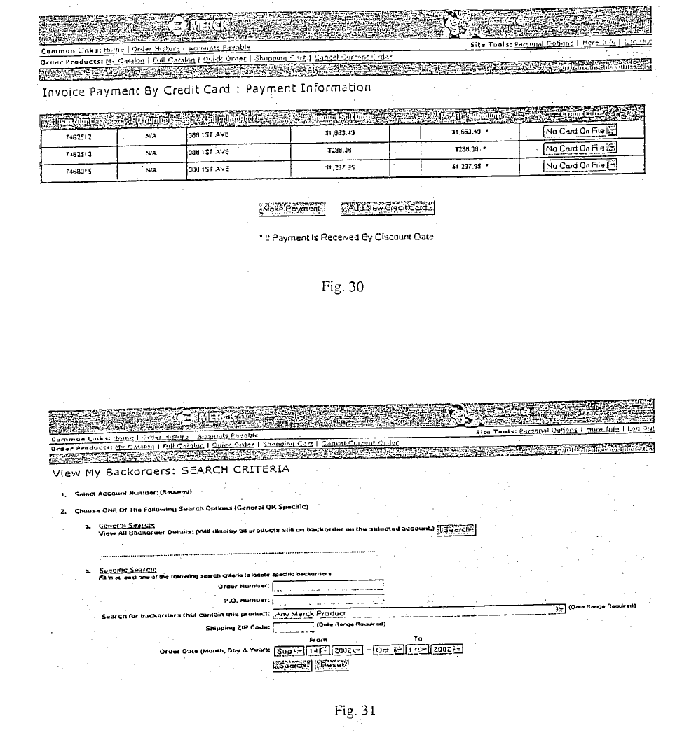

FIG. 30 provides a customer screen for making an invoice payment by way of credit or debit card. After selecting certain invoices or credits on the search results page, and clicking “Pay Checked Invoices,” this screen will appear, and the customer may choose a credit or debit card on which to apply payment of the invoice. Optionally, the customer may add credit and debit cards to his profile.

FIG. 31 provides a customer screen for searching backorders that are outstanding on an account. From the home page, by clicking “View My Backorders,” this screen will appear. The customer may use a general search to simply view all backordered items, or he may enter data in any of the fields at the bottom half of the screen to perform a more specific search.

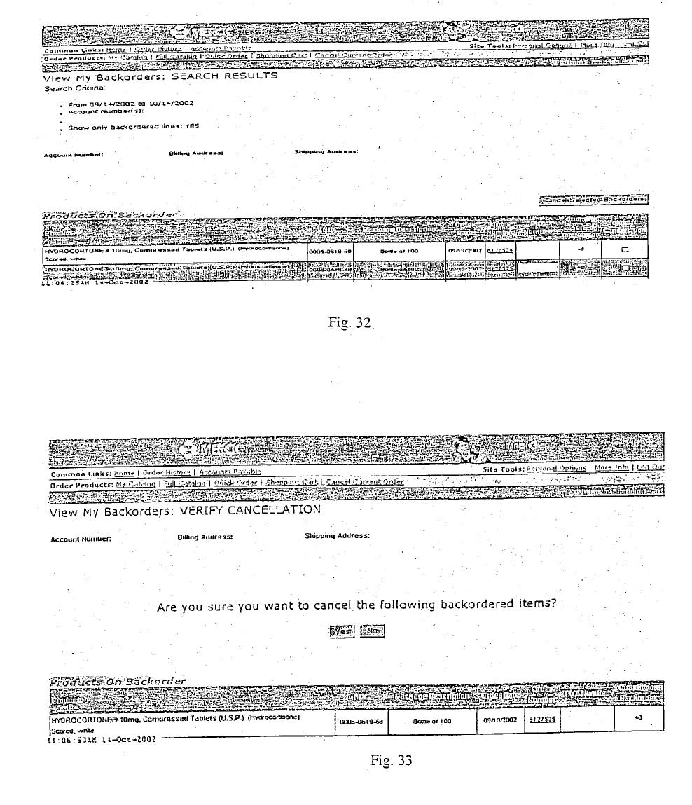

FIG. 32 provides a customer screen for viewing the results of a backorder search. In table format, i.e. columns and rows, a list of outstanding backorders that match particular search criteria are displayed from which the customer may select any backorders for cancellation.

FIG. 33 provides a customer screen for the verification of cancellation of outstanding backorders that have not been filled. From the page “View My Backorders: Search Results” of FIG. 32, the customer may click on the button “Yes” to verify cancellation of a selected backorder.

In another embodiment of the invention, a customer's records in the database may be customized to identify all contracts that may apply different pricing features for available products, wherein the pricing features may be automatically updated or changed in real time. The present invention may access contract database containing a customer's contract information and integrate it with current product pricing to automatically establish new pricing information in real time. Information on each contract may be made available to the system from records from the contract database. Thus, the present invention can calculate product pricing for orders based on contracts and product pricing updates. Based on the contract information, the present invention may automatically prices each product ordered to give the customer the benefit of the contract terms, and displays such prices to a customer during order confirmation.

A customer may attach an identifier to the order. Such identifier may be, for example, a purchase order number or the like. In fact, the customer's record in the database may include a field that requires the customer to attach an identifier to the order.

Once received by the manufacturer, a first confirmation including a confirmation number may be displayed as an HTML web page. Thereafter, a second confirmation in the form of an email message to the customer may be sent.

The present invention may operate in conjunction with several databases in the course of receiving and fulfilling an order. Such databases include an order management database, an accounts receivable database, and but not limited to, a contract database. In addition, the present invention may operate with and/or provide information to sales and marketing databases.

It should be appreciated that changes can be made to the embodiments described above without departing from the inventive concepts herein. It should be understood, therefore, that this invention is not limited to the particular embodiments disclosed, but it is intended to cover modifications within the spirit and scope of the present invention, as will become readily apparent to those skilled in the art.

What is claimed is:

1. A method of ordering pharmaceutical products and vaccines by way of electronic data interchange, characterized as an automated system having product information stored therein, the information being accessible by entry to a website, the website being characterized as having software suitable for establishing a user account, accepting and placing pharmaceutical product and vaccine orders, calculating product order information and providing the same to the user, deleting product orders therefrom, and tracking product shipments, comprising:
accessing the website to view pharmaceutical products and vaccines specification information by the user;
selecting certain pharmaceutical products for order based on the specification information by the user;
accessing an account under which to order the pharmaceutical products and vaccines by the user;
inputting pharmaceutical product and vaccine selection and quantity information, based on the ordering information, into the website by the user;
providing specifications, pricing and availability information regarding the selected pharmaceutical products and vaccines by the website; and
ordering the selected pharmaceutical products and vaccines from the website by the user,
wherein the system is operable on a real time basis for integrating pharmaceutical product and vaccine availability information with current product pricing, specifications and prescribing information; accepting and canceling orders, based on pharmaceutical and vaccine products availability; and providing order shipment information.

2. The method according to claim 1, wherein accessing an account comprises entering a user name and password into the system.

3. The method according to claim 2, product and vaccine information is selected from product name, national drug code, formulary, product size, product price, the like, product availability, and combinations thereof.

4. The method according to claim 3, wherein product and vaccine information further include prescribing and dosing information.

5. The method according to claim 4, wherein product and vaccine specifications, pricing and availability information comprises real time information regarding the current pricing and availability of products and vaccines.

6. The method according to claim 5, wherein accessing an account comprises establishing and accessing an individual user account comprising individual user information selected from name, shipping addresses, password, credit and debit card accounts, site preferences, order history, user profile, the like and combinations thereof.

7. The method according to claim 7, wherein the site preferences are selected from customization of product and vaccine-catalogs and specifications, order screens, and manufacturer news articles, and combinations thereof.

8. The method according to claim 4, wherein the prescribing and dosing information further provide product group information.

9. The method according to claim 8, wherein unavailable products and vaccines may be ordered on a backorder basis.

10. The method according to claim 9, wherein backorders of products and vaccines may be canceled after order placement and before shipment thereof.
